(19) United States
(12) Patent Application Publication
(10) Pub. No.: US 2018/0147890 A1
(43) Pub. Date: May 31, 2018

(54) PNEUMATIC TIRE

(71) Applicant: TOYO TIRE & RUBBER CO., LTD., Itami-shi (JP)

(72) Inventor: Harunobu Suita, Itami-shi (JP)

(73) Assignee: TOYO TIRE & RUBBER CO., LTD., Itami-shi (JP)

(21) Appl. No.: 15/791,564

(22) Filed: Oct. 24, 2017

(30) Foreign Application Priority Data
Nov. 29, 2016 (JP) 2016-230992

(51) Int. Cl. B60C 11/01; B60C 11/13

(52) U.S. Cl. CPC B60C 11/01; B60C 2011/0348; B60C 11/13

(57) ABSTRACT

A pneumatic tire is provided with tread including a shoulder lug extending in the tire circumferential direction. The shoulder lug is provided with a narrow groove extending in the tire circumferential direction and includes a sacrificial lug portion disposed toward the exterior in the tire width direction from the narrow groove. The outline of the sacrificial lug portion includes a first arc and a second arc disposed toward the interior in the tire width direction from the first arc. The two ends of first arc include a first end and second end disposed toward the exterior in the tire radial direction, and toward the interior in the tire width direction, from first end. The two ends of second arc include a first end and a second end disposed toward the interior in the tire radial direction, and toward the interior in the tire width direction, from the first end.

### TECHNICAL FIELD

The present disclosure relates to a pneumatic tire that is provided with defense groove(s) (hereinafter “narrow groove(s)”).

### BACKGROUND ART

At a running pneumatic tire, contact patch pressure at shoulder lugs on the tread surface in the vicinity of the edge of the contact patch being high, the amount of wear at shoulder lugs in the vicinity of the edge of the contact patch is ordinarily greater than at lugs elsewhere on the tread surface.

To prevent such uneven wear, shoulder lugs are sometimes provided with narrow grooves which extend in the tire circumferential direction and which, as viewed in a section in the tire width direction, extend radially in linear fashion. The narrow grooves cause shoulder lugs to be divided into main lug portions toward the interior in the tire width direction from the narrow groove, and sacrificial lug portions toward the exterior in the tire width direction from the narrow groove, as a result of which wear of the main lug portions is suppressed.

### PRIOR ART REFERENCES

### Patent References

PATENT REFERENCE NO. 1: Japanese Patent No. 3320837
PATENT REFERENCE NO. 2: Japanese Patent Application Publication Kokai No. 2002-46418
PATENT REFERENCE NO. 3: Japanese Patent No. 5222239
PATENT REFERENCE NO. 4: Japanese Patent Application Publication Kokai No. 2005-81918

### SUMMARY OF INVENTION

### Problem to be Solved by Invention

When a tire is provided with such a narrow groove, it is sometimes the case, as viewed in a section in the tire width direction, that the outline at the apex of the sacrificial lug portion is constituted from an arc of the same curvature as the arc from which the outline at the apex of the main lug portion is constituted.

However, at a tire having a sacrificial lug portion of such configuration, contact patch pressure at the narrow-groove-side crest of the sacrificial lug portion will be high, and there will during rolling of the tire be large amounts of compressive strain and tensile strain at the sacrificial lug portion, making strain energy high, as a result of which there will be a tendency for cracking to occur at the two walls making up the sacrificial lug portion and the groove bottom.

The present disclosure was conceived in light of such situation, it being an object thereof to provide a pneumatic tire having improved resistance to cracking at sacrificial lug portion(s) and groove bottom(s).

### Means for Solving Problem

A pneumatic tire in accordance with the present disclosure is provided with a tread comprising a shoulder lug extending in a tire circumferential direction;

wherein the shoulder lug is equipped with a narrow groove extending in the tire circumferential direction;

the shoulder lug comprises a sacrificial lug portion which is disposed at a location toward the exterior in the tire width direction from the narrow groove;

an outline of the sacrificial lug portion as viewed in a section in the tire width direction comprises, at an apex of the sacrificial lug portion, a first arc and a second arc which is disposed at a location toward the interior in the tire width direction from the first arc;

two ends of the first arc comprise a first end, and a second end which is disposed at a location toward the exterior in the tire radial direction and toward the interior in the tire width direction from the first end:

two ends of the second arc comprise a first end, and a second end which is disposed at a location toward the interior in the tire radial direction and toward the interior in the tire width direction from the first end; and

a radius of curvature of the first arc is greater than a radius of curvature of the second arc.

In accordance with the present disclosure, as a result of the fact that the outline at the apex of a sacrificial lug portion is constituted from a first arc and from a second arc which is disposed at a location toward the interior in the tire width direction from the first arc and which has a radius of curvature smaller than the radius of curvature of the first arc, the amount by which contact patch pressure can be reduced at the narrow-groove-side crest of the sacrificial lug portion is made larger than the amount by which contact patch pressure can be reduced at the shoulder-lug-edge-side crest of the sacrificial lug portion, making it possible to optimize ground contact pressure at the sacrificial lug portion. It is therefore possible to improved resistance to cracking at sacrificial lug portion(s) and groove bottom(s).

At a pneumatic tire in accordance with the present disclosure, it is preferred that

the shoulder lug further comprise a main lug portion which is disposed at a location toward the interior in the tire width direction from the narrow groove:

an outline of the main lug portion as viewed in a section in the tire width direction comprise a main lug portion line segment that constitutes a portion of a wall at the narrow groove;

the narrow groove comprise a first region extending in parallel fashion with respect to the main lug portion line segment, and a second region which is disposed at a location deeper than the first region in the tire radial direction; and

as viewed in a section in the tire width direction, the second region be of curved shape, curving in such fashion as to cause distance to a tire equatorial plane to decrease with increasing depth. This is so as to make it possible to reduce contact patch pressure at main lug portion locations in the vicinity of the narrow groove and so as to permit improvement with respect to resistance to uneven wear.

At a pneumatic tire in accordance with the present disclosure, it is preferred that an outline of the second region as viewed in a section in the tire width direction not comprise any corners. This is so as to make it possible to distribute strain that might otherwise become concentrated at groove bottom(s) and so as to permit improvement in resistance to cracking at groove bottom(s).

At a pneumatic tire in accordance with the present disclosure, it is preferred that an outline of the sacrificial lug portion comprise a line segment that extends from the second end of the second arc 31 so as not to be inclined with respect to the tire radial direction and/or a line segment that extends from the second end of the second arc so as to be inclined toward a tire equatorial plane by an amount that is not more than 7° with respect to the tire radial direction. Where line segment(s) are inclined with respect to the tire radial direction, this will permit improvement in the rigidity of sacrificial lug portion(s) and will permit reduction in strain that might otherwise become concentrated at groove bottom(s).

### BRIEF DESCRIPTION OF DRAWINGS

FIG. 1 Drawing showing section in the tire width direction of a shoulder lug at a pneumatic tire in accordance with a first embodiment.

FIG. 2 Drawing showing section in the tire width direction of a shoulder lug at a pneumatic tire in accordance with a first variation.

FIG. 3 Drawing showing section in the tire width direction of a shoulder lug at a pneumatic tire in accordance with a second variation.

FIG. 4 Drawing showing section in the tire width direction of a shoulder lug in a test tire at Working Example 1.

FIG. 5 Drawing showing section in the tire width direction of a shoulder lug in a test tire at Comparative Example 1

### EMBODIMENTS FOR CARRYING OUT INVENTION

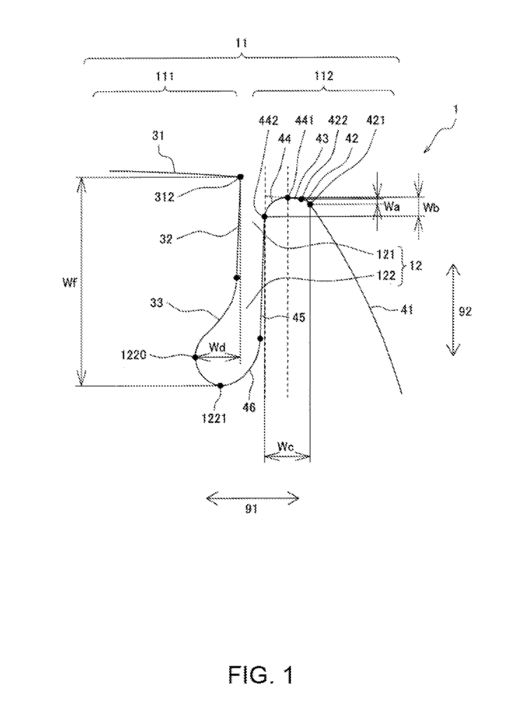

A first embodiment in accordance with the present disclosure is described below. At FIG. 1, 91 indicates the tire width direction. The tire width direction is the direction which is perpendicular to the equatorial plane of the tire. 92 indicates the tire radial direction. A “section in the tire width direction” is a section cut straight through the pneumatic tire in such fashion as to pass through the two ends of the rotational axis of the tire.

As shown in FIG. 1, a pneumatic tire in accordance with a first embodiment is provided with tread 1 comprising a shoulder lug 11 extending in the tire circumferential direction. Shoulder lug 11 is provided with narrow groove(s) 12 extending in the tire circumferential direction. Although not shown in FIG. 1, tread 1 is provided with major groove(s) extending in the tire circumferential direction at location(s) toward the interior in the tire width direction from shoulder lug 11. Width of the major groove(s) is greater than width of narrow groove(s) 12. Width of the major groove(s) might, for example, be 5 mm to 20 mm.

Shoulder lug 11 comprises sacrificial lug portion(s) 112 disposed at location(s) toward the exterior in the tire width direction from narrow groove(s) 12. At the apex of sacrificial lug portion 112, the outline of sacrificial lug portion 112, as viewed in a section in the tire width direction, comprises first arc 42 and second arc 44 which is disposed at a location toward the interior in the tire width direction from first arc 42. The outline of sacrificial lug portion 112 further comprises third arc 43 at the apex of sacrificial lug portion 112. The outline of sacrificial lug portion 112 further comprises line segment 45, fourth arc 46, and fifth arc 41.

The two ends of first arc 42 comprise first end 421 and second end 422 which is disposed at a location toward the exterior in the tire radial direction, and toward the interior in the tire width direction, from first end 421. First arc 42 connects third arc 43 and fifth arc 41 in such fashion as to cause the side crest of sacrificial lug portion 112 to gradually decline in height. The radius of curvature of first arc 42 is greater than the radius of curvature of second arc 44. Radius of curvature of first arc 42 might, for example, be not less than 0.5 mm. The upper limit of the range in values for the radius of curvature of first arc 42 might, for example, be 3 mm. Length of first arc 42 might, for example, be not less than 0.3 mm. The upper limit of the range in values for the length of first arc 42 might, for example, be 2.6 mm. The center of curvature of first arc 42 may be disposed at a location toward the interior in the tire radial direction from an imaginary line extending in the tire width direction and passing through first end 421 of first arc 42.

The two ends of second arc 44 comprise first end 441 and second end 442 which is disposed at a location toward the interior in the tire radial direction, and toward the interior in the tire width direction, from first end 441. Second arc 44 connects third arc 43 and line segment 45 in such fashion as to cause the side crest of sacrificial lug portion 112 to gradually decline in height. Radius of curvature of second arc 44 might, for example, be not less than 0.2 mm. The upper limit of the range in values for the radius of curvature of second arc 44 might, for example, be 1.5 mm. Length of second arc 44 might, for example, be not less than 0.3 mm. The upper limit of the range in values for the length of second arc 44 might, for example, be 2.5 mm. The center of curvature of second arc 44 may be disposed at a location toward the interior in the tire radial direction from an imaginary line extending in the tire width direction and passing through second end 442 of second arc 44. Or instead of being disposed at that location, the center of curvature of second arc 44 may be disposed on an imaginary line extending in the tire width direction and passing through second end 442 of second arc 44.

While not exactly linear, third arc 43 is very nearly so as it describes the locus of an arc extending in the tire width direction. Third arc 43 connects first arc 42 and second arc 44. Radius of curvature of third arc 43 might, for example, be not less than 400 mm. Length of third arc 43 might, for example, be not less than 0.5 mm. The upper limit of the range in values for the length of third arc 43 might, for example, be 2.7 mm. The center of curvature of third arc 43 may be disposed at a location toward the interior in the tire radial direction from an imaginary line which is the extension of third arc 43 to the tire equatorial plane.

The outline of sacrificial lug portion 112 comprises line segment 45. Line segment 45 constitutes a portion of a wall face at narrow groove 12. Line segment 45 may extend from second end 442 of second arc 44 so as to be inclined toward the tire equatorial plane by an amount that is not more than 7° with respect to the tire radial direction. Alternatively, line segment 45 may extend from second end 442 of second arc 44 so as not to be inclined with respect to the tire radial direction. Length of line segment 45 might, for example, be not less than 5 mm. The upper limit of the range in values for the length of line segment 45 might, for example, be 10 mm.

The outline of sacrificial lug portion 112 comprises fourth arc 46. Fourth arc 46 constitutes a portion of a wall face at narrow groove 12. Fourth arc 46 extends toward the tire equatorial plane from the inner end in the tire radial direction of line segment 45. Radius of curvature of fourth arc 46 might, for example, be not less than 5 mm. The upper limit of the range in values for the radius of curvature of fourth arc 46 might, for example, be 9 mm. Length of fourth arc 46 might, for example, be not less than 4 mm. The upper limit of the range in values for the length of fourth arc 46 might, for example, be 6 mm. The center of curvature of fourth arc 46 may be disposed at a location toward the interior in the tire width direction from an imaginary line extending in the tire radial direction and passing through the deepest point 1221 in the tire radial direction of narrow groove 12.

The outline of sacrificial lug portion 112 comprises fifth arc 41. Fifth arc 41 extends away from the tire equatorial plane from first end 421 of first arc 42. Radius of curvature of fifth arc 41 might, for example, be not less than 30 mm. The upper limit of the range in values for the radius of curvature of fifth arc 41 might, for example, be 60 mm. The center of curvature of fifth arc 41 may be disposed at a location toward the interior in the tire width direction from an imaginary line extending in the tire radial direction and passing through first end 421 of first arc 42.

Distance Wa between an imaginary line extending in the tire width direction and passing through first end 421 of first arc 42 and an imaginary line extending in the tire width direction and passing through second end 422 of first arc 42 might, for example, be 0.2 mm to 1.5 mm.

Distance Wb between an imaginary line extending in the tire width direction and passing through first end 441 of second arc 44 and an imaginary line extending in the tire width direction and passing through second end 442 of second arc 44 might, for example, be 0.1 mm to 1.5 mm.

Distance Wc between an imaginary line extending in the tire radial direction and passing through first end 421 of first arc 42 and an imaginary line extending in the tire radial direction and passing through second end 442 of second arc 44 might, for example, be 2 mm to 5 mm.

Shoulder lug 11 further comprises main lug portion(s) 111 disposed at location(s) toward the interior in the tire width direction from narrow groove(s) 12. The outline of main lug portion 111, as viewed in a section in the tire width direction, comprises first arc 31, line segment 32, and second arc 33.

The outline of main lug portion 111 comprises first arc 31 at the apex of main lug portion 111. First arc 31 constitutes a portion of the tread surface at tread 1. While not exactly linear, first arc 31 is very nearly so as it describes the locus of an arc extending in the tire width direction. It is preferred that first arc 31 be offset from third arc 43. By this it is meant at least that third arc 43 and an imaginary line which is the extension of first arc 31 into the region above sacrificial lug portion 112 do not mutually intersect. The two ends of first arc 31 comprise a first end and a second end 312 which is disposed at a location toward the exterior in the tire width direction from the first end. The preferred range of values for the radius of curvature of first arc 31 is the same as that of third arc 43. Length of first arc 31 might, for example, be not less than 30 mm. The upper limit of the range in values for the length of first arc 31 might, for example, be 60 mm. The center of curvature of first arc 31 may be disposed at a location toward the interior in the tire radial direction from an imaginary line which is the extension of first arc 31 to the tire equatorial plane.

The outline of main lug portion 111 comprises line segment 32. Line segment 32 constitutes a portion of a wall face at narrow groove 12. Line segment 32 connects first arc 31 and second arc 33. Line segment 32 may extend from second end 312 of first arc 31 so as not to be inclined with respect to the tire radial direction. Alternatively, line segment 32 may extend from second end 312 of first arc 31 so as to be inclined toward the tire equatorial plane by an amount that is not more than 7° with respect to the tire radial direction. It is preferred that line segment 32 be parallel to line segment 45. When line segment 32 is parallel to line segment 45, the distance between line segment 32 and line segment 45 might, for example, be 1 mm to 5 mm. Length of line segment 32 might, for example, be not less than 3 mm. The upper limit of the range in values for the length of line segment 32 might, for example, be 8 mm.

The outline of main lug portion 111 comprises second arc 33. Second arc 33 extends toward the tire equatorial plane from the inner end in the tire radial direction of line segment 32. It is preferred that the radius of curvature of second arc 33 be smaller than the radius of curvature of fourth arc 46. It is also possible for the radius of curvature of second arc 33 to be the same as the radius of curvature of fourth arc 46. Radius of curvature of second arc 33 might, for example, be not less than 2 mm. The upper limit of the range in values for the radius of curvature of second arc 33 might, for example, be 8 mm. Length of second arc 33 might, for example, be not less than 2.5 mm. The upper limit of the range in values for the length of second arc 33 might, for example, be 7 mm. The center of curvature of second arc 33 may be disposed at a location toward the interior in the tire width direction from an imaginary line extending in the tire radial direction and passing through the deepest point 1220 in the tire width direction of narrow groove 12.

Narrow groove 12 comprises first region 121 extending in parallel fashion with respect to line segment 32 and second region 122 which is disposed at a location deeper than first region 121 in the tire radial direction. As viewed in a section in the tire width direction, second region 122 is of curved shape, the curvature being such as to bring it closer to the tire equatorial plane as the depth thereof increases. It is preferred that second region 122 have a portion at which width increases with increasing depth. It is preferred that the outline of second region 122 not comprise any corners as viewed in a section in the tire width direction. Moreover, it is preferred that the outline of the bottom of narrow groove 12 as viewed in a section in the tire width direction be rounded, and more preferred that this be made up of a single arc.

The shortest distance Wd between the deepest point 1220 in the tire width direction of second region 122 and an imaginary line extending in the tire radial direction and passing through second end 312 of first arc 31 might, for example, be not less than 1 mm. The upper limit of the range in values for Wd might, for example, be 5 mm.

Distance Wf between an imaginary line extending in the tire width direction and passing through second end 312 of first arc 31 and an imaginary line extending in the tire width direction and passing through the deepest point 1221 in the tire radial direction of narrow groove 12 might, for example, be 10 mm to 16 mm. The value of Wf may be the same or nearly the same as the depth of the major groove.

It is preferred that the pneumatic tire of the first embodiment be capable of being employed as a pneumatic tire intended for heavy loads.

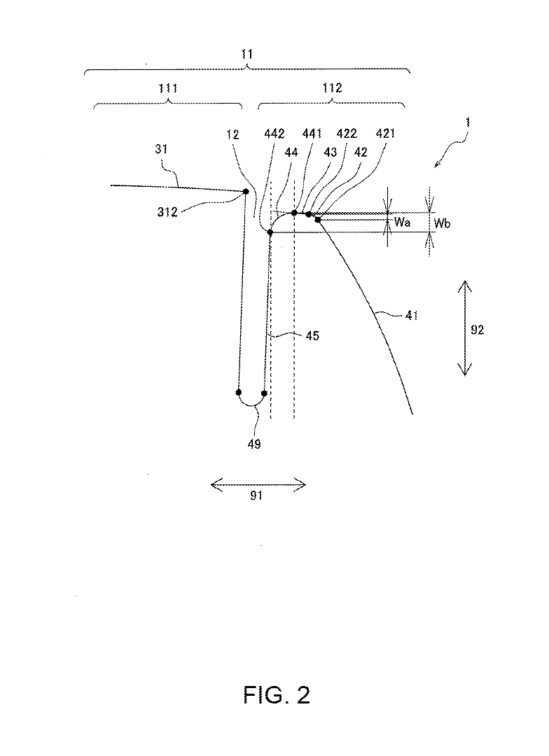

As shown in FIG. 2, a pneumatic tire in accordance with a first variation is identical to that in accordance with the first embodiment except for the fact that narrow groove 12 does not comprise a second region 122. The outline of the bottom of narrow groove 12 as viewed in a section in the tire width direction does not comprise any corners. It is preferred that the outline of the bottom of narrow groove 12 be rounded, and more preferred that this be made up of a single arc 49.

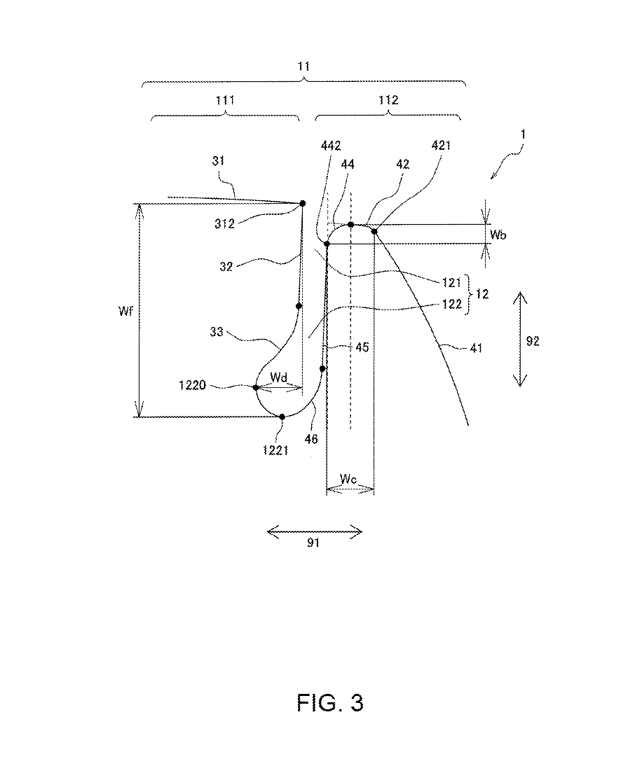

As shown in FIG. 3, a pneumatic tire in accordance with a second variation is identical to that in accordance with the first embodiment except for the fact that the outline of sacrificial lug portion 112 does not comprise a third arc 43.

### WORKING EXAMPLES

Working examples and the like which illustrate the constitution and effect of the present invention in specific terms are described below.

### Working Example 1

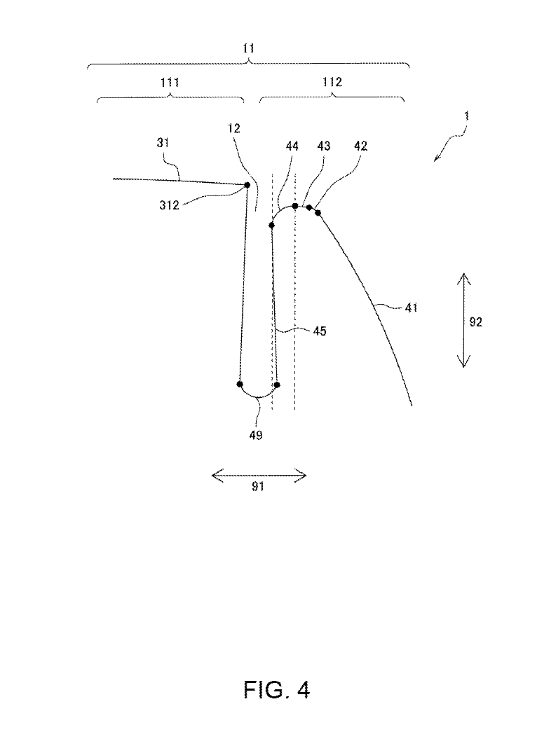

This was a test tire (295/75R22.5) having the configuration shown in FIG. 4. Radius of curvature of first arc 42 was 2 mm, and radius of curvature of second arc 44 was 1 mm. The angle of inclination of line segment 45 was −2°. An “angle of inclination of −2°” means that line segment 45 extended from second end 442 of second arc 44 so as to be inclined away from the tire equatorial plane by an amount that was 2° with respect to the tire radial direction.

### Working Example 2

This was a test tire (295/75R22.5) having the configuration shown in FIG. 1. Radius of curvature of first arc 42 was 2 mm, and radius of curvature of second arc 44 was 1 mm. The angle of inclination of line segment 45 was 3°. An “angle of inclination of 3°” means that line segment 45 extended from second end 442 of second arc 44 so as to be inclined toward the tire equatorial plane by an amount that was 3° with respect to the tire radial direction.

### Comparative Example 1

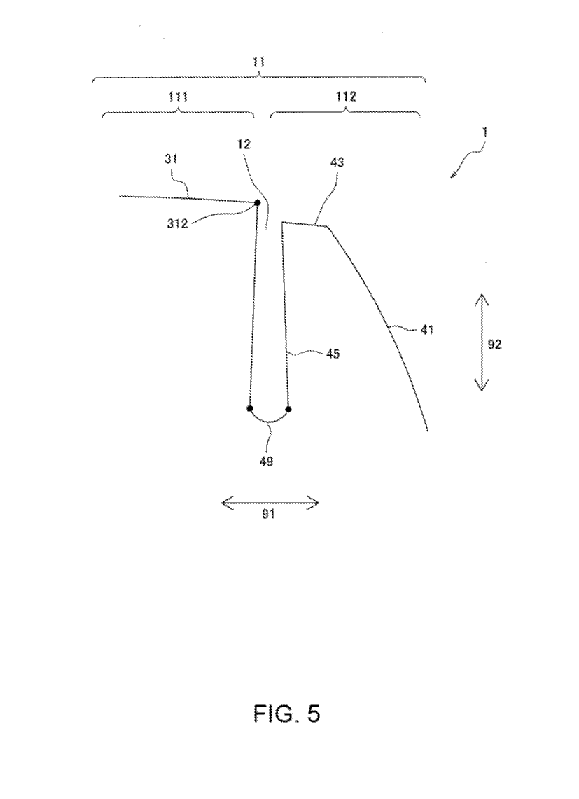

This was a test tire (295/75R22.5) having the configuration shown in FIG. 5. Except for the fact that first arc 42 and second arc 44 were not present, the test tire of Comparative Example 1 was identical to that of Working Example 1.

### Comparative Example 2

Except for the fact that radius of curvature of first arc 42 was changed to 1 mm and radius of curvature of second arc 44 was changed to 2 mm, this was identical to the test tire of Working Example 1.

### Resistance to Cracking at Groove Bottom

The test tire was assembled onto a wheel of rim size 22.5×8.25, and a drum-type apparatus was used to carry out testing under conditions of 760 kPa air pressure, 60 km/h speed, and 21.8 kN load. Crack width at the groove bottom was measured after 15000 km of travel. Measured values for the respective examples are shown indexed relative to a value of 100 for that measured at Comparative Example 1. The larger the value the smaller the crack width and the more excellent the resistance to cracking at the groove bottom.

### Resistance to Cracking at Wall

Crack width at the defense groove wall (sacrificial lug portion 112) was measured after 15000 km of travel. Measured values for the respective examples are shown indexed relative to a value of 100 for that measured at Comparative Example 1. The larger the value the smaller the crack width and the more excellent the resistance to cracking at the wall.

TABLE 1

| | Compar- | Compar- | Work- | Work- |
|---|---|---|---|---|
| | ative | ative | ing | ing |
| | Example 1 | Example 2 | Example 1 | Example 2 |
| Radius of curvature of | — | 2 | 1 | 1 |
| second arc 44 | | | | |
| Radius of curvature of | — | 1 | 2 | 2 |
| first arc 42 | | | | |
| Shape of cross-section of | Straight | Straight | Straight | Curved |
| narrow groove | | | | |
| Angle of inclination of | −2 | −2 | −2 | 3 |
| line segment 45 | | | | |
| Resistance to cracking | 100 | 102 | 107 | 113 |
| at groove bottom | | | | |
| Resistance to cracking | 100 | 98 | 103 | 110 |
| at wall | | | | |

Causing the outline at the apex of sacrificial lug portion 112 to be made up of second arc 44 and of first arc 42 which had radius of curvature greater than second arc 44 improved resistance to cracking at the groove bottom and resistance to cracking at the wall.

1. A pneumatic tire provided with a tread comprising a shoulder lug extending in a tire circumferential direction;
wherein the shoulder lug is equipped with a narrow groove extending in the tire circumferential direction;
the shoulder lug comprises a sacrificial lug portion which is disposed at a location toward the exterior in the tire width direction from the narrow groove;
an outline of the sacrificial lug portion as viewed in a section in the tire width direction comprises, at an apex of the sacrificial lug portion, a first arc and a second arc which is disposed at a location toward the interior in the tire width direction from the first arc;
two ends of the first arc comprise a first end, and a second end which is disposed at a location toward the exterior in the tire radial direction and toward the interior in the tire width direction from the first end;
two ends of the second arc comprise a first end, and a second end which is disposed at a location toward the interior in the tire radial direction and toward the interior in the tire width direction from the first end; and
a radius of curvature of the first arc is greater than a radius of curvature of the second arc.

2. The pneumatic tire according to claim 1 wherein
the shoulder lug further comprises a main lug portion which is disposed at a location toward the interior in the tire width direction from the narrow groove;
an outline of the main lug portion as viewed in a section in the tire width direction comprises a main lug portion line segment that constitutes a portion of a wall at the narrow groove;
the narrow groove comprises a first region extending in parallel fashion with respect to the main lug portion line segment, and a second region which is disposed at a location deeper than the first region in the tire radial direction; and
as viewed in a section in the tire width direction, the second region is of curved shape, curving in such fashion as to cause distance to a tire equatorial plane to decrease with increasing depth.

3. The pneumatic tire according to claim 2 wherein an outline of the second region as viewed in a section in the tire width direction does not comprise any corners.

4. The pneumatic tire according to claim 1 wherein an outline of the sacrificial lug portion comprises a line segment that extends from the second end of the second arc so as not to be inclined with respect to the tire radial direction and/or a line segment that extends from the second end of the second arc so as to be inclined toward a tire equatorial plane by an amount that is not more than 7° with respect to the tire radial direction.

5. The pneumatic tire according to claim 1 wherein a radius of curvature of the first arc is not less than 0.5 mm.

6. The pneumatic tire according to claim 1 wherein an upper limit of the range in values for a radius of curvature of the first arc is 3 mm.

7. The pneumatic tire according to claim 1 wherein a radius of curvature of the second arc is not less than 0.2 mm.

8. The pneumatic tire according to claim 1 wherein a distance Wa between an imaginary line extending in the tire width direction and passing through the first end of the first arc and an imaginary line extending in the tire width direction and passing through the second end of the first arc is 0.2 mm to 1.5 mm.

9. The pneumatic tire according to claim 1 wherein a distance Wb between an imaginary line extending in the tire width direction and passing through the first end of the second arc and an imaginary line extending in the tire width direction and passing through the second end of the second arc is 0.1 mm to 1.5 mm.

10. The pneumatic tire according to claim 1 wherein a distance Wc between an imaginary line extending in the tire radial direction and passing through the first end of the first arc and an imaginary line extending in the tire radial direction and passing through the second end of the second arc is 2 mm to 5 mm.

11. The pneumatic tire according to claim 1 wherein an upper limit of the range in values for the radius of curvature of the second arc is 1.5 mm.

12. The pneumatic tire according to claim 1 wherein a length of the first arc is not less than 0.3 mm.

13. The pneumatic tire according to claim 1 wherein an upper limit of the range in values for the length of the first arc is not less than 2.6 mm.

14. The pneumatic tire according to claim 1 wherein a length of the second arc is not less than 0.3 mm.

15. The pneumatic tire according to claim 1 wherein an upper limit of the range in values for the length of the second arc is 2.5 mm.
